(19) United States
(12) Patent Application Publication
(10) Pub. No.: US 2024/0263328 A1
(43) Pub. Date: Aug. 8, 2024

(54) BIMETALLIC IRON-COBALT NANOCARBIDE ELECTROCATALYSTS FOR THE OXYGEN EVOLUTION REACTION

(71) Applicant: Florida State University Research Foundation, Inc., Tallahassee, FL (US)

(72) Inventors: Robert A. Lazenby, Tallahassee, FL (US); Geoffrey F. Strouse, Tallahassee, FL (US); Amanda J. RITZ, Tallahassee, FL (US); Isabella A. BERTINI, Tallahassee, FL (US)

(21) Appl. No.: 18/433,570

(22) Filed: Feb. 6, 2024

Related U.S. Application Data
(60) Provisional application No. 63/444,133, filed on Feb. 8, 2023.

(51) Int. Cl. C25B 11/075; C01B 32/90; C25B 1/04; C25B 11/052; H01M 4/90

(52) U.S. Cl. CPC C25B 11/075; C01B 32/90; C25B 1/04; C25B 11/052; C01P 2002/72; C01P 2002/76; C01P 2002/85; C01P 2004/04; C01P 2004/62; C01P 2004/64; C01P 2006/40; H01M 4/90

(57) ABSTRACT

For renewable energy technology to become ubiquitous, it is imperative to develop efficient oxygen evolution reaction (OER) electrocatalysts, which is challenging due to the kinetically and thermodynamically unfavorable OER mechanism. In accordance with the purpose(s) of the present disclosure, described herein are iron/cobalt carbide compounds. The electrochemical performance of carbides can fine-tuned via Fe incorporation and with control, or suppression, of the growth of the oxide phase on the carbide catalytic surface.

### CROSS-REFERENCE TO RELATED APPLICATIONS

This application claims the benefit of and priority to co-pending U.S. Provisional Patent Application No. 63/444,133, filed on Feb. 8, 2023, the contents of which are incorporated by reference herein in their entireties.

### BACKGROUND

Electrochemical water splitting offers a promising route for sourcing green hydrogen, a renewable energy alternative to fossil fuels.¹⁻³ However, the anodic four-electron oxygen evolution reaction (OER) mechanism is kinetically sluggish and thermodynamically unfavorable under alkaline conditions.^{4,5} Despite tremendous efforts in the search for new catalysts to utilize in electrochemical water splitting systems,^{6,7} costly ruthenium and iridium oxide (RuO₂ and IrO₂) electrocatalysts persist as the only viable options for industrial implementation.⁸⁻¹¹ Therefore, the development of alternative highly efficient and low cost electrocatalysts for the OER remains crucial in decreasing the overall energy demand of water splitting.

### SUMMARY

For renewable energy technology to become ubiquitous, it is imperative to develop efficient oxygen evolution reaction (OER) electrocatalysts, which is challenging due to the kinetically and thermodynamically unfavorable OER mechanism. In accordance with the purpose(s) of the present disclosure, described herein are iron/cobalt carbide compounds. The electrochemical performance of carbides can fine-tuned via Fe incorporation and with control, or suppression, of the growth of the oxide phase on the carbide catalytic surface.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims. In addition, all optional and preferred features and modifications of the described embodiments are usable in all aspects of the disclosure taught herein. Furthermore, the individual features of the dependent claims, as well as all optional and preferred features and modifications of the described embodiments are combinable and interchangeable with one another.

### BRIEF DESCRIPTION OF THE DRAWINGS

Further aspects of the present disclosure will be more readily appreciated upon review of the detailed description of its various embodiments, described below, when taken in conjunction with the accompanying drawings.

FIGS. 1A-1B show (a) 3D contour plot tracking the evolution of the major carbide phase as a function of % Fe. The black intensity represents the XRD signal, I, normalized to the maximum signal, Iₘₐₓ, where the most intense peaks appear black. Phase references are broadened to reflect 10 nm materials and overlaid to highlight differences. The references shown are for M₇C₃ (dark blue, ICSD: 76830), M₅C₂ (light blue, ICSD: 423885), M₃C (blue-green, ICSD: 43521) and M₂C (green, COD: 1528415). b) Proposed crystalline phase diagram of metastable bimetallic carbides, where relative phase contributions are plotted against % Fe. The error plot (top) represents the % error in each fit. Fits for each sample are shown in SI Figure S4.

FIGS. 2A-2B show (a) Representative linear sweep voltammograms of FeCo nanocarbides in 1.0 M KOH, with a dashed line denoting the benchmarking standard current density of 10 mA cm⁻². Note that RuO₂ achieved an overpotential of 0.36 V at 10 mA cm⁻² (per geometric surface area). b) The linear regions of the Tafel plots were fitted, using the voltammetry from part a) to determine Tafel slopes, indicated by the dashed lines. Note that the Tafel slope obtained for RuO₂ was 85 mV dec⁻¹.

FIGS. 3A-3B show (a) Overpotentials (n=3) required to achieve 10 mA cm⁻² (per ECSA) for FeₓCo₁₋ₓC_{y} of varying % Fe, in 1.0 M KOH. The color gradient shows the crystal phases determined by XRD analysis. b) Tafel slopes for FeₓCo₁₋ₓC_{y} of varying % Fe.

FIGS. 4A-4C show (a) CVs of the 1^{st}, 25^{th}, and 200^{th} cycle at a scan rate of 5 mV s⁻¹ for the FeCo nanocarbide, containing 15% Fe. b) Overpotentials were extracted from CVs at a current density of 10 mA cm⁻² over 200 cycles. c) Percentage stacked bar graph showing major phase contribution from Co₃C (i.e. carbide) and (Fe_{0.5}Co_{0.5})₂O₄ (i.e. oxide) derived from XRD analysis of 15% FeCo post-electrocatalytic OER, with increasing CV cycles, using a Mo K_{α} source.

FIG. 5 shows SEM images of FeCo Prussian blue analogue (PBA) precursors.

FIG. 6 shows powder x-ray diffraction of PBA precursors.

FIG. 7 shows powder x-ray diffraction of 0-100% of varying Fe content in all FeₓCo₁₋ₓC_{y} produced for electrocatalytic study.

FIG. 8 shows the contribution of varying phases fitted to each FeₓCo₁₋ₓC_{y} powder XRD pattern.

FIG. 9 shows TEM images of select FeₓCo₁₋ₓC_{y}.

FIG. 10 shows powder XRD of Fe, Co and 15% Fe FeCo oxides.

FIG. 11 shows the SEM micrograph of drop casted nanomaterial modified glassy carbon surface.

FIGS. 12A-12B show representative double-layer capacitance measurements for determining electrochemically active surface area for an FeCo nanocarbide.

FIG. 13 shows XPS fits for select FeₓCo₁₋ₓC_{y} samples.

FIGS. 14A-14B show XPS quantification of oxide surface in as synthesized FeₓCo₁₋ₓC_{y} samples.

FIG. 15A-15B show the electrochemical stability of commercial RuO₂ nanoparticles.

FIGS. 16A-16B show the linear sweep voltammograms (LSVs) of PBA-derived 15% Fe containing FeCo oxide.

The drawings illustrate only example embodiments and are therefore not to be considered limiting of the scope described herein, as other equally effective embodiments are within the scope and spirit of this disclosure. The elements and features shown in the drawings are not necessarily drawn to scale, emphasis instead being placed upon clearly illustrating the principles of the embodiments. Additionally, certain dimensions may be exaggerated to help visually convey certain principles. In the drawings, similar reference numerals between figures designate like or corresponding, but not necessarily the same, elements.

### DETAILED DESCRIPTION

Before the present compounds, compositions, articles, devices, and/or methods are disclosed and described, it is to be understood that the aspects described below are not limited to specific compounds, synthetic methods, or uses as such may, of course, vary. It is also to be understood that the terminology used herein is for the purpose of describing particular aspects only and is not intended to be limiting.

Although specific terms are employed herein, they are used in a generic and descriptive sense only and not for purposes of limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure.

Any recited method can be carried out in the order of events recited or in any other order that is logically possible. That is, unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention. Further, the dates of publication provided herein can be different from the actual publication dates, which can require independent confirmation.

While aspects of the present disclosure can be described and claimed in a particular statutory class, such as the system statutory class, this is for convenience only and one of skill in the art will understand that each aspect of the present disclosure can be described and claimed in any statutory class.

It is also to be understood that the terminology used herein is for the purpose of describing particular aspects only and is not intended to be limiting. Unless defined otherwise, all technical and scientific terms used herein have the same meaning as commonly understood by one of ordinary skill in the art to which the disclosed compositions and methods belong. It will be further understood that terms, such as those defined in commonly used dictionaries, should be interpreted as having a meaning that is consistent with their meaning in the context of the specification and relevant art and should not be interpreted in an idealized or overly formal sense unless expressly defined herein.

Prior to describing the various aspects of the present disclosure, the following definitions are provided and should be used unless otherwise indicated. Additional terms may be defined elsewhere in the present disclosure.

### Definitions and Abbreviations

In describing and claiming the disclosed subject matter, the following terminology will be used in accordance with the definitions set forth below.

As used herein, “comprising” is to be interpreted as specifying the presence of the stated features, integers, steps, or components as referred to, but does not preclude the presence or addition of one or more features, integers, steps, or components, or groups thereof. Moreover, each of the terms “by”, “comprising,” “comprises”, “comprised of,” “including,” “includes,” “included,” “involving,” “involves,” “involved,” and “such as” are used in their open, non-limiting sense and may be used interchangeably. Further, the term “comprising” is intended to include examples and aspects encompassed by the terms “consisting essentially of” and “consisting of.” Similarly, the term “consisting essentially of” is intended to include examples encompassed by the term “consisting of.

As used in the specification and the appended claims, the singular forms “a,” “an” and “the” include plural referents unless the context clearly dictates otherwise. Thus, for example, reference to “a solvent” includes, but are not limited to, mixtures or combinations of two or more such solvents, and the like.

It should be noted that ratios, concentrations, amounts, rates, and other numerical data can be expressed herein in a range format. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about,” it will be understood that the particular value forms a further aspect. For example, if the value “about 10” is disclosed, then “10” is also disclosed and “about 5 to about 15” is also disclosed.

When a range is expressed, a further aspect includes from the one particular value and/or to the other particular value. For example, where the stated range includes one or both of the limits, ranges excluding either or both of those included limits are also included in the disclosure, e.g. the phrase “x to y” includes the range from ‘x’ to ‘y’ as well as the range greater than ‘x’ and less than ‘y’. The range can also be expressed as an upper limit, e.g. ‘about x, y, z, or less’ and should be interpreted to include the specific ranges of ‘about x’, ‘about y’, and ‘about z’ as well as the ranges of ‘less than x’, less than y’, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y’, and ‘greater than z’. In addition, the phrase “about ‘x’ to ‘y’”, where ‘x’ and ‘y’ are numerical values, includes “about ‘x’ to about ‘y’”.

It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range.

As used herein, the terms “about,” “approximate,” “at or about,” and “substantially” mean that the amount or value in question can be the exact value or a value that provides equivalent results or effects as recited in the claims or taught herein. That is, it is understood that amounts, sizes, formulations, parameters, and other quantities and characteristics are not and need not be exact but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In such cases, it is generally understood, as used herein, that “about” and “at or about” mean the nominal value indicated ±10% variation unless otherwise indicated or inferred. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of embodiments described in the specification.

Disclosed are the components to be used to prepare the compositions of the invention as well as the compositions themselves to be used within the methods disclosed herein. These and other materials are disclosed herein, and it is understood that when combinations, subsets, interactions, groups, etc. of these materials are disclosed that while specific reference of each various individual and collective combinations and permutation of these compounds cannot be explicitly disclosed, each is specifically contemplated and described herein. For example, if a particular compound is disclosed and discussed and a number of modifications that can be made to a number of molecules including the compounds are discussed, specifically contemplated is each and every combination and permutation of the compound and the modifications that are possible unless specifically indicated to the contrary. Thus, if a class of molecules A, B, and C are disclosed as well as a class of molecules D, E, and F and an example of a combination molecule, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the compositions of the invention. Thus, if there are a variety of additional steps that can be performed it is understood that each of these additional steps can be performed with any specific embodiment or combination of embodiments of the methods of the invention.

It is understood that the compositions disclosed herein have certain functions. Disclosed herein are certain structural requirements for performing the disclosed functions, and it is understood that there are a variety of structures that can perform the same function that are related to the disclosed structures, and that these structures will typically achieve the same result.

As used herein, the terms “optional” or “optionally” means that the subsequently described event or circumstance can or cannot occur, and that the description includes instances where said event or circumstance and instances where it does not.

### Iron/Cobalt Carbide Compounds and Applications Thereof

For renewable energy technology to become ubiquitous, it is imperative to develop efficient oxygen evolution reaction (OER) electrocatalysts, which is challenging due to the kinetically and thermodynamically unfavorable OER mechanism. In accordance with the purpose(s) of the present disclosure, described herein are iron/cobalt carbide compounds. The electrochemical performance of carbides can fine-tuned via Fe incorporation and with control, or suppression, of the growth of the oxide phase on the carbide catalytic surface.

In one aspect, the relative amount of iron to cobalt can be used to tune the electrocatalytic activity of the iron/cobalt carbide compounds described herein. In one aspect, the molar ratio of cobalt to iron is from about 2:1 to about 5:1, or about 2:1, 2.5:1, 3:1, 3.5:1, 4:1, 4.5:1, or 5:1, where any value can be a lower and upper endpoint of a range (e.g., 3.5:1 to 4.5:1).

In another aspect, the iron/cobalt carbide compounds described herein have the formula Fe_{X}Co_{1-X}C, wherein X is from about 0.05 to about 0.30. In one aspect, X is about 0.05, 0.10, 0.15, 0.20, 0.25, or 0.30, where any value can be a lower and upper endpoint of a range (e.g., 0.15 to 0.25).

In one aspect, the iron/cobalt carbide compounds described herein are produced by produced by
(a) mixing an iron salt with a cobalt salt in water to produce FeCo Prussian blue analog (PBA); and
(b) heating PBA to produce the iron/cobalt carbide compound.

The Examples provide non-limiting procedures for making the iron/cobalt carbide compounds described herein. In one aspect, K₃Fe(CN)₆ and K₃Co(CN)₆ are mixed in water, where the relative molar amount of the iron and cobalt salts is varied. Additional salts such as, for example, FeCl₂ or COCl₂ can be added to form the FeCo Prussian blue analog (PBA). PBA is formed as crystals that can subsequently be isolated. PBA is next heated to produce the iron/cobalt carbide compounds. In one aspect, PBA is heated at a temperature of from about 250° C. to about 500° C. In another aspect, PBA is heated at a temperature at about 250° C., 300° C., 350° C., 400° C., 450° C., or 500° C., where any value can be a lower and upper endpoint of a range (e.g., 300° C. to 350° C.).

The iron/cobalt carbide compounds described herein possess several properties that make them suitable for the oxygen evolution reaction (OER). In one aspect, the iron/cobalt carbide compounds have an overpotential of from about 0.30 V to about 0.50 V, or about 0.30 V, 0.32 V, 0.34 V, 0.36 V, 0.38 V, 0.40 V, 0.42 V, 0.44 V, 0.46 V, 0.48 V, or 0.50 V, where any value can be a lower and upper endpoint of a range (e.g., 0.36 V to 0.44 V). In one aspect, the iron/cobalt carbide compounds have a Tafel slope of from about 70 mV dec⁻¹ to about 90 mV dec⁻¹, or about 70 mV dec⁻¹, 72 mV dec⁻¹, 74 mV dec⁻¹, 76 mV dec⁻¹, 78 mV dec⁻¹, 80 mV dec⁻¹, 82 mV dec⁻¹, 84 mV dec⁻¹, 86 mV dec⁻¹, 88 mV dec⁻¹, or 90 mV dec⁻¹, where any value can be a lower and upper endpoint of a range (e.g., 74 mV dec⁻¹ to 84 mV dec⁻¹). In another aspect, the iron/cobalt carbide compounds have a particle size from about 5 nm to about 100 nm.

The iron/cobalt carbide compounds described herein exist as one or more crystal phases. In one aspect, the iron/cobalt carbide compound includes a Co₃C orthorhombic phase. In another aspect, the iron/cobalt carbide compound includes a Co₃C orthorhombic phase and a Co₂C orthorhombic phase.

In one aspect, the iron/cobalt carbide compound has an X-ray powder diffraction pattern comprising a peak at from 42.0° to 43.0° 2θ as measured by X-ray powder diffraction using an x-ray wavelength of 1.54 Å, or from 42.0°, 42.1°, 42.2°, 42.3°, 42.4°, 42.5°, 42.6°, 42.7°, 42.8°, 42.9°, or 43.0°, where any value can be a lower and upper endpoint of a range (e.g., 42.1° to 42.8°). In another aspect, the iron/cobalt carbide compound has an X-ray powder diffraction pattern comprising a peak at 42.7°±0.2° 2θ as measured by X-ray powder diffraction using an x-ray wavelength of 1.54 Å.

In another aspect, The iron/cobalt carbide compound has an X-ray powder diffraction pattern comprising a peak at from 41.0° to 42.0° 2θ as measured by X-ray powder diffraction using an x-ray wavelength of 1.54 Å, or from 41.0°, 41.1°, 41.2°, 41.3°, 41.4°, 41.5°, 41.6°, 41.7°, 41.8°, 41.9°, or 42.0°, where any value can be a lower and upper endpoint of a range (e.g., 41.1° to 41.8°). In another aspect, the iron/cobalt carbide has an X-ray powder diffraction pattern comprising peaks at 41.4°±0.2° 2θ as measured by X-ray powder diffraction using an x-ray wavelength of 1.54 Å.

In another aspect, the iron/cobalt carbide compound has an X-ray powder diffraction pattern comprising a peak at from 45.0° to 46.0° 2θ as measured by X-ray powder diffraction using an x-ray wavelength of 1.54 Å, or from 45.0°, 45.1°, 45.2°, 45.3°, 45.4°, 45.5°, 45.6°, 45.7°, 45.8°, 45.9°, or 46.0°, where any value can be a lower and upper endpoint of a range (e.g., 45.1° to 45.8°). In another aspect, the iron/cobalt carbide compound has an X-ray powder diffraction pattern comprising peaks at 45.5°±0.2° 2θ as measured by X-ray powder diffraction using an x-ray wavelength of 1.54 Å.

In another aspect, the iron/cobalt carbide compound has an X-ray powder diffraction pattern comprising a peak at from 37.0° to 38.0° 2θ as measured by X-ray powder diffraction using an x-ray wavelength of 1.54 Å, or from 37.0°, 37.1°, 37.2°, 37.3°, 37.4°, 37.5°, 37.6°, 37.7°, 37.8°, 37.9°, or 38.0°, where any value can be a lower and upper endpoint of a range (e.g., 45.1° to 45.8°). In another aspect, the iron/cobalt carbide compound has an X-ray powder diffraction pattern comprising peaks at 37.1°±0.2° 2θ as measured by X-ray powder diffraction using an x-ray wavelength of 1.54 Å.

The iron/cobalt carbide compounds described herein can be applied to one or more electrodes employed in an oxygen evolution system. Examples of these systems include, but are not limited to, water electrolysis systems, solar fuels generators, electrowinning systems, electrolytic hydrogen generators, reversible fuel cells, and reversible air batteries. The iron/cobalt carbide compounds can be deposited or applied to the electrode surface using techniques known in the art. In one aspect, a solution of the iron/cobalt carbide compounds can be prepared and the electrode can be inserted into the solution. The Examples provide non-limiting procedures for applying the iron/cobalt carbide compounds to electrodes.

### Aspects

Aspect 1. An iron/cobalt carbide compound, wherein the molar ratio of cobalt to iron is from about 2:1 to about 5:1.

Aspect 2. The iron/cobalt carbide compound of Aspect 1, wherein the compound has the formula Fe_{X}Co_{1-X}C, wherein X is from about 0.05 to about 0.30.

Aspect 3. The iron/cobalt carbide compound of Aspect 2, wherein X is from about 0.15 to about 0.25.

Aspect 4. An iron/cobalt carbide compound produced by the process comprising
(a) mixing an iron salt with a cobalt salt in water to produce FeCo Prussian blue analog (PBA); and
(b) heating PBA to produce the iron/cobalt carbide compound.

Aspect 5. The iron/cobalt carbide compound of Aspect 4, wherein the iron salt comprises K₃Fe(CN)₆ and the cobalt salt comprises K₃Co(CN)₆.

Aspect 6. The iron/cobalt carbide compound of Aspect 4, wherein step (a) further comprises adding a second iron salt or a second cobalt salt.

Aspect 7. The iron/cobalt carbide compound of Aspect 6, wherein the second iron salt comprises FeCl₂ and the second cobalt salt comprises CoCl₂.

Aspect 8. The iron/cobalt carbide compound of any one of Aspects 4-7, wherein PBA is heated at a temperature of from about 250° C. to about 500° C.

Aspect 9. The iron/cobalt carbide compound of any one of Aspects 1-8, wherein the compound has a particle size from about 5 nm to about 100 nm.

Aspect 10. The iron/cobalt carbide compound of any one of Aspects 1-8, wherein the compound has an overpotential of from about 0.30 V to about 0.50 V.

Aspect 11. The iron/cobalt carbide compound of any one of Aspects 1-8, wherein the compound has a Tafel slope of from about 70 mV dec⁻¹ to about 90 mV dec⁻¹.

Aspect 12. The iron/cobalt carbide compound of any one of Aspects 1-8, wherein the iron/cobalt carbide compound comprises a Co₃C orthorhombic phase.

Aspect 13. The iron/cobalt carbide compound of any one of Aspects 1-8, wherein the iron/cobalt carbide compound comprises a Co₃C orthorhombic phase and a Co₂C orthorhombic phase.

Aspect 14. The iron/cobalt carbide compound of any one of Aspects 1-8, wherein the compound has an X-ray powder diffraction pattern comprising a peak at from 42.0° to 43.0° 2θ as measured by X-ray powder diffraction using an x-ray wavelength of 1.54 Å.

Aspect 15. The iron/cobalt carbide compound of any one of Aspects 1-8, wherein the compound has an X-ray powder diffraction pattern comprising a peak at 42.7°±0.2° 2θ as measured by X-ray powder diffraction using an x-ray wavelength of 1.54 Å.

Aspect 16. The iron/cobalt carbide compound of any one of Aspects 1-8, wherein the compound has an X-ray powder diffraction pattern comprising a peak at from 41.0° to 42.0° 2θ as measured by X-ray powder diffraction using an x-ray wavelength of 1.54 Å.

Aspect 17. The iron/cobalt carbide compound of any one of Aspects 1 to 8, wherein the compound has an X-ray powder diffraction pattern comprising peaks at 41.4°±0.2° 2θ as measured by X-ray powder diffraction using an x-ray wavelength of 1.54 Å.

Aspect 18. The iron/cobalt carbide compound of any one of Aspects 1-8, wherein the compound has an X-ray powder diffraction pattern comprising a peak at from 45.0° to 46.0° 2θ as measured by X-ray powder diffraction using an x-ray wavelength of 1.54 Å.

Aspect 19. The iron/cobalt carbide compound of any one of Aspects 1 to 8, wherein the compound has an X-ray powder diffraction pattern comprising peaks at 45.5°±0.2° 2θ as measured by X-ray powder diffraction using an x-ray wavelength of 1.54 Å.

Aspect 20. The iron/cobalt carbide compound of any one of Aspects 1-8, wherein the compound has an X-ray powder diffraction pattern comprising a peak at from 37.0° to 38.0° 2θ as measured by X-ray powder diffraction using an x-ray wavelength of 1.54 Å.

Aspect 21. The iron/cobalt carbide compound of any one of Aspects 1 to 8, wherein the compound has an X-ray powder diffraction pattern comprising peaks at 37.1°±0.2° 2θ as measured by X-ray powder diffraction using an x-ray wavelength of 1.54 Å.

Aspect 22. An electrode comprising the iron/cobalt carbide compound of any one of Aspects 1-21.

Aspect 23. The electrode of Aspect 22, wherein the iron/cobalt carbide compound comprises a film on the surface of the electrode.

Aspect 24. An oxygen evolution system comprising one or more electrodes of Aspects 22 and 23.

Aspect 25. The system of Aspect 24, wherein the system comprises a water electrolysis system, a solar fuel generator, an electrowinning system, an electrolytic hydrogen generator, a reversible fuel cell, or a reversible air battery.

### EXAMPLES

Now having described the embodiments of the disclosure, in general, the examples describe some additional embodiments. While embodiments of the present disclosure are described in connection with the example and the corresponding text and figures, there is no intent to limit embodiments of the disclosure to these descriptions. On the contrary, the intent is to cover all alternatives, modifications, and equivalents included within the spirit and scope of embodiments of the present disclosure.

### EXPERIMENTAL SECTION

Materials. All commercially available reagents were used without further purification. Precursors for FeCo PBAs were K₃Co(CN)₆ and K₃Fe(CN)₆ (Sigma Aldrich, >99%), KCl (Sigma Aldrich, 98%), CoCl₂.6H₂O (Thermo Fisher, >99%), and FeCl₂.4H₂O (Thermo Fisher, >99%). Solvents used for synthesis were ultrapure water (18.2 Ωcm⁻¹ at 25.0° C., Thermo Fisher Barnstead E-Pure Ultrapure filtration system), octadecylamine (Thermo Fisher, 90%), acetone (VWR, ACS Grade) and toluene (VWR, ACS Grade).

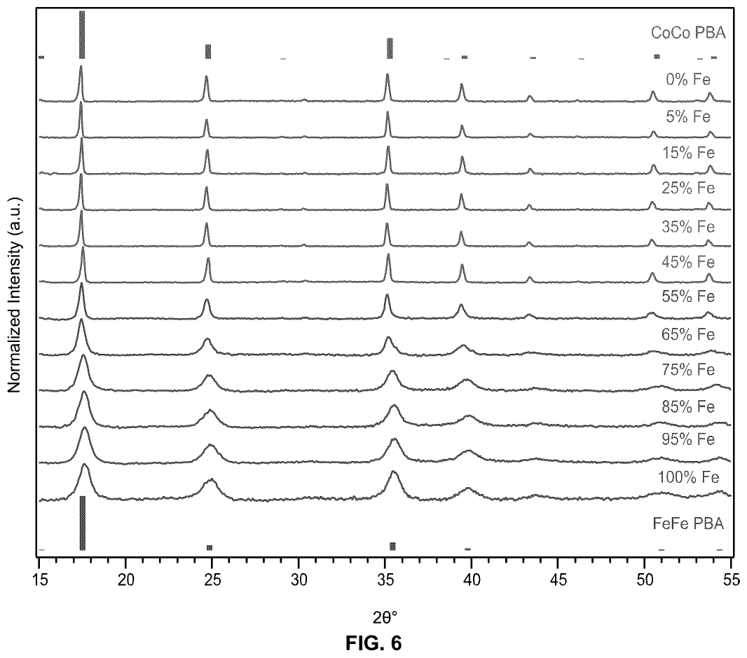

Synthesis of FeCo Prussian Blue Analogue (PBA) Precursors. Two precursor solutions were prepared, and upon combination a precipitation reaction occurred to form the PBA. Briefly, x mmol K₃Fe(CN)₆ and 1−x mmol K₃Co(CN)₆ (where x=0, 0.1, 0.3, 0.5, 0.7, 0.9, 1), 5 mmol of KCl in 100 mL of ultrapure water, comprised solution 1. Solution 2 comprised 1 mmol of either FeCl₂ (to make PBAs of >50% Fe) or CoCl₂ (to make PBAs of <50% Fe) in 200 mL of ultrapure water. Solution 2 was added dropwise to solution 1 at a rate of 5 mL min⁻¹ and vigorously stirred. The subsequent reaction solutions were left for 18 hrs while stirring to grow the PBAs. The PBAs were collected via centrifugation, washed with 300 mL of ultrapure water and dried on the benchtop at room temperature. The PBA precursors were characterized using scanning electron microscopy ((SEM), FIG. 5, powder X-ray diffraction ((pXRD), FIG. 6), and X-ray fluorescence ((XRF), Table 1).

TABLE 1
X-ray fluorescence (XRF) elemental composition for FeCo PBA
precursors and FeCo carbides. Results show ratio of metals
are maintained from precursor to resultant carbide.

| Sample (PBA | | | Sample (FeCo | | |
|---|---|---|---|---|---|
| Precursors) | % Fe | % Co | Carbide) | % Fe | % Co |
| 100% Fe | 99 | 1 | 100% Fe | 100 | 0 |
| 95% Fe | 93 | 7 | 95% Fe | 93 | 7 |
| 85% Fe | 95 | 5 | 85% Fe | 95 | 5 |
| 75% Fe | 84 | 16 | 75% Fe | 80 | 20 |
| 65% Fe | 72 | 28 | 65% Fe | 71 | 29 |
| 55% Fe | 60 | 40 | 55% Fe | 60 | 40 |
| 45% Fe | 33 | 67 | 45% Fe | 35 | 65 |
| 35% Fe | 26 | 74 | 35% Fe | 27 | 73 |
| 25% Fe | 18 | 82 | 25% Fe | 20 | 80 |
| 20% Fe | 14 | 86 | 20% Fe | 14 | 86 |
| 15% Fe | 12 | 88 | 15% Fe | 12 | 88 |
| 5% Fe | 7 | 93 | 5% Fe | 4 | 96 |
| 0% Fe | 0 | 100 | 0% Fe | 0 | 100 |

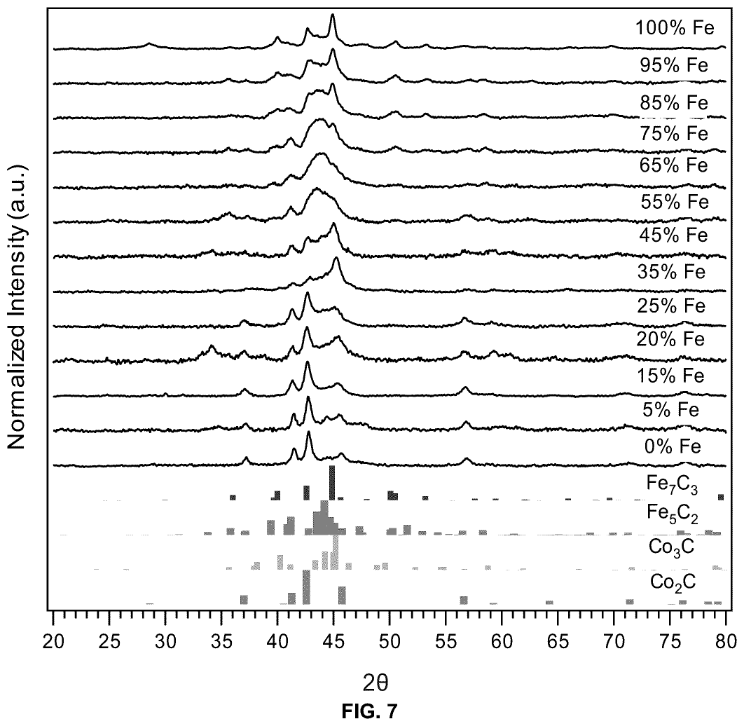

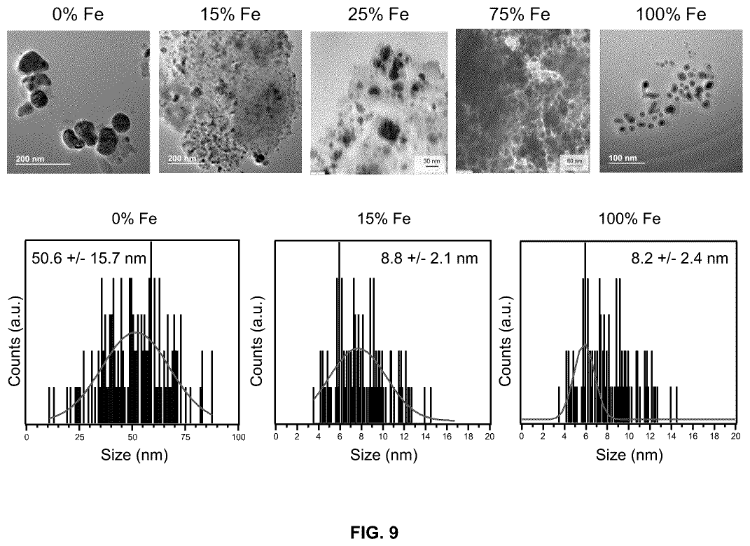

Synthesis of FeCo Nanocarbides. 200 mg of solid PBA and 40 mL of octadecylamine (ODA) were heated to 330° C., under inert atmosphere for 24 hrs. After 24 hrs, the reaction was quenched using toluene and the resultant nanocarbide was collected via magnetic separation. The nanoparticles were washed with toluene (3×), acetone (1×), ultrapure water (3×), and again with acetone (1×), then dried in an oven at 100° C. for 15 minutes. The nanoparticles were structurally characterized using pXRD (Rigaku Miniflex benchtop powder diffractometer, Cu Kα (more details available in FIG. 7)). Elemental composition was confirmed using XRF spectroscopy (Panalytical Epsilon X-ray florescence analyzer, Table 1). Morphology and size analyses were executed using transmission electron microscopy (TEM, FEI CM300 FEG, details in FIG. 9).

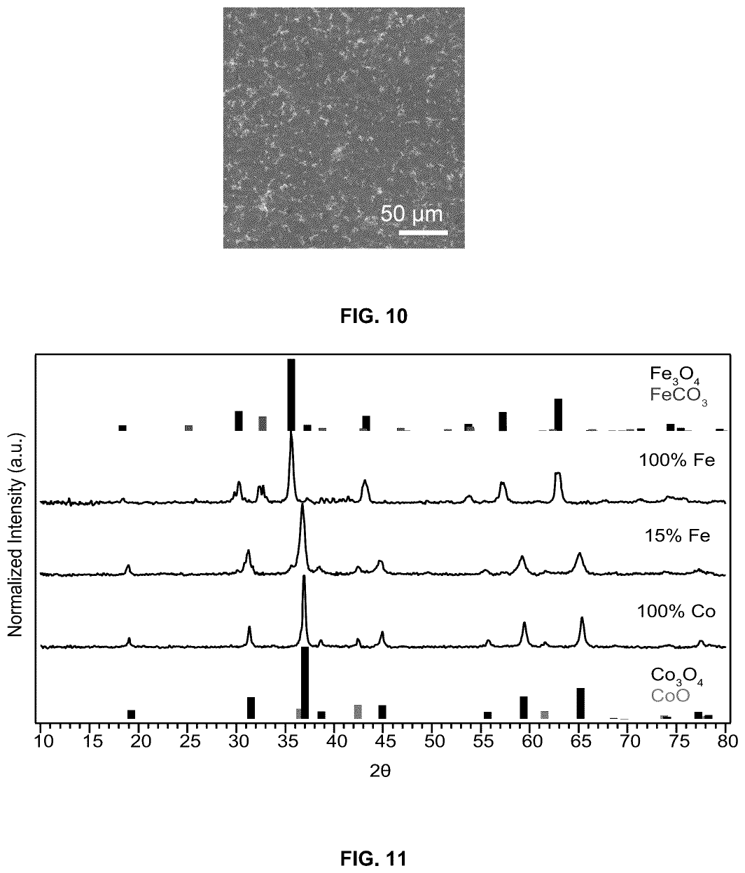

Synthesis of FeCo Oxides. 200 mg of solid PBA was loaded into an aluminum boat and placed into a Lindberg tube furnace. The PBA was subsequently heated to 300° C. with a ramp rate of 60° C. min⁻¹, for 30 minutes. The resultant oxides were structurally characterized with pXRD (FIG. 10).

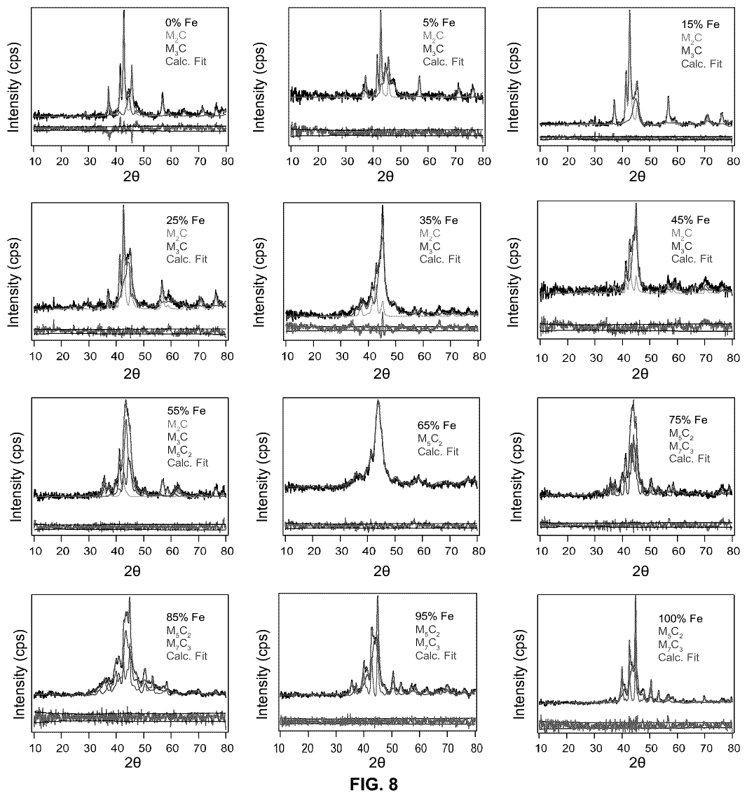

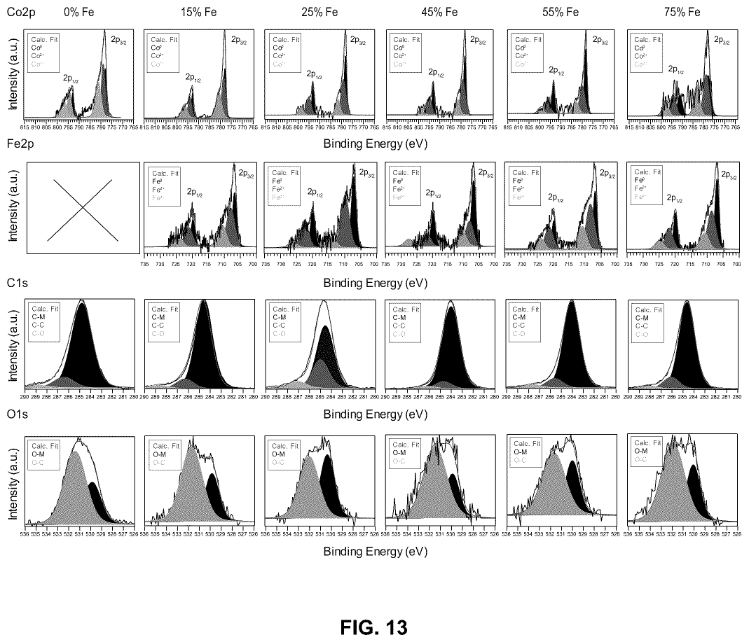

Materials Characterization. Powder X-ray diffraction patterns of PBAs, PBA derived carbides and PBA derived oxides were collected at room temperature on a Rigaku Miniflex powder diffractometer (Cu Kα source, λ=1.54 Å, FIGS. 6, 7, and 10). The contributions of various crystalline phases were fitted and calculated as a percentage for each FeₓCo₁₋ₓC_{y}, using fits shown in FIG. 8. PXRD measurements on post-OER samples were performed on a Rigaku Synergy single crystal diffractometer running in powder diffraction mode (Mo Kα source, λ=0.71 Å, FIG. 10). The bimetallic ratio in both PBA and nanocarbide were confirmed using XRF on a Panalytical Epsilon X-ray florescence analyzer (Cu Kα source, Table 1). X-ray photoelectron spectroscopy (XPS) was performed on as-synthesized powders deposited on carbon tape using a PHI 5100 X-ray photoelectron spectrometer (Mg Kα source) with a pass energy of 22.36 eV. The XPS spectra were fitted using CasaXPS software, details in FIG. 13. Samples were Ar⁺-sputtered using a sputtering gun at 5 keV and 1 μA for 15 minutes to reveal underlying carbide features. All samples were calibrated to the aliphatic carbon assignment (C1s, 284.8 eV). Size and morphology of PBA precursors were investigated via SEM imaging (FEI Nova 400, 15 keV, FIG. 5). Size, size dispersity, and morphology of the nanocarbides were estimated using ImageJ software (sample size=100 particles) via TEM images (FIG. 10) collected on a Tecnai Osiris TEM operating at 200 kV. The peak positions for each iron/cobalt carbide compound as well as iron/cobalt phases are provided in tables below.

| | peak | Normalized | | peak | Normalized | | | |
|---|---|---|---|---|---|---|---|---|
| | position | peak | | position | peak | | | |
| Sample | (2θ) | intensity | | (2θ) | intensity | | | |
| 0% Fe | 37.2 | 0.24 | 5% Fe | 37.15 | 0.21698 | 15% Fe | 37.05 | 0.21827 |
| | 41.4 | 0.4698 | | 41.4 | 0.46865 | | 41.35 | 0.46627 |
| | 42.75 | 0.97144 | | 42.7 | 0.9737 | | 42.7 | 1 |
| | 44.35 | 0.20851 | | 44.4 | 0.42147 | | 45.3 | 0.38266 |
| | 45.65 | 0.34824 | | 45.45 | 0.48237 | | 56.75 | 0.25817 |
| | 56.7 | 0.19178 | | 56.7 | 0.24599 | | | |

| | peak | Normalized | | peak | Normalized | | peak | Normalized |
|---|---|---|---|---|---|---|---|---|
| | position | peak | | position | peak | | position | peak |
| | (2θ) | intensity | | (2θ) | intensity | | (2θ) | intensity |
| 20% Fe | 34.1 | 0.48501 | 25% Fe | 37.05 | 0.20508 | 35% Fe | 41.3 | 0.24122 |
| | 37.05 | 0.32811 | | 41.35 | 0.50458 | | 42.9 | 0.44572 |
| | 41.35 | 0.40913 | | 42.7 | 1 | | 45.25 | 1 |
| | 42.7 | 1 | | 45.3 | 0.51 | | | |
| | 45.45 | 0.74339 | | 56.7 | 0.24849 | | | |
| | 56.7 | 0.2688 | | | | | | |
| | 59.25 | 0.29976 | | | | | | |

| | peak | Normalized | | peak | Normalized | | peak | Normalized |
|---|---|---|---|---|---|---|---|---|
| | position | peak | | position | peak | | position | peak |
| | (2θ) | intensity | | (2θ) | intensity | | (2θ) | intensity |
| 45% Fe | 34.15 | 0.22665 | 55% Fe | 35.65 | 0.28404 | 65% Fe | 39.6 | 0.15699 |
| | 41.25 | 0.32082 | | 37.3 | 0.17701 | | 41.2 | 0.39299 |
| | 42.7 | 0.58917 | | 41.15 | 0.43778 | | 43.8 | 1 |
| | 45 | 1 | | 43.5 | 1 | | 45 | 0.69357 |
| | | | | 45.2 | 0.61275 | | 57 | 0.13297 |
| | | | | 56.9 | 0.2113 | | 58.6 | 0.14988 |

| | peak | Normalized | | peak | Normalized | | peak | Normalized |
|---|---|---|---|---|---|---|---|---|
| | position | peak | | position | peak | | position | peak |
| | (2θ) | intensity | | (2θ) | intensity | | (2θ) | intensity |
| 75% Fe | 35.55 | 0.15392 | 85% Fe | 40 | 0.26921 | 95% Fe | 35.6 | 0.13319 |
| | 37.35 | 0.095931 | | 41 | 0.26398 | | 37.15 | 0.097782 |
| | 39.6 | 0.17925 | | 42.7 | 0.65598 | | 40.05 | 0.33114 |
| | 41.2 | 0.44562 | | 43.6 | 0.77883 | | 41 | 0.25267 |
| | 44.05 | 1 | | 44.9 | 1 | | 42.9 | 0.67874 |
| | 44.9 | 0.8545 | | 50.6 | 0.19284 | | 44 | 0.56846 |
| | 50.5 | 0.18947 | | 53.2 | 0.12903 | | 44.95 | 1 |
| | | | | 58.35 | 0.10526 | | 50.55 | 0.24819 |
| | | | | | | | 53.3 | 0.12801 |
| | | | | | | | 58 | 0.095775 |
| | | | | | | | 58.3 | 0.11234 |

| | peak | Normalized | | peak | Normalized | | peak | Normalized |
|---|---|---|---|---|---|---|---|---|
| | position | peak | | position | peak | | position | peak |
| | (2θ) | intensity | | (2θ) | intensity | | (2θ) | intensity |
| Co3C | 37 | 0.234 | Fe5C2 | 39.411 | 0.43 | Fe7C3 | 36.02 | 0.15577 |
| | 40.232 | 0.442 | | 40.874 | 0.317 | | 39.989 | 0.27115 |
| | 41.134 | 0.159 | | 41.193 | 0.531 | | 42.581 | 0.42115 |
| | 43.37 | 0.281 | | 43.503 | 0.682 | | 44.879 | 1 |
| | 44.233 | 0.538 | | 44.187 | 1 | | 50.074 | 0.27019 |
| | 45.191 | 1 | | 44.706 | 0.527 | | 50.498 | 0.2865 |
| | 46.348 | 0.2 | | 45.085 | 0.358 | | | |
| | 48.865 | 0.15 | | 45.764 | 0.198 | | | |
| | 49.591 | 0.21 | | 47.31 | 0.25 | | | |
| | 58.764 | 0.133 | | 51.558 | 0.3 | | | |
| | | | | 58.307 | 0.149 | | | |

| | peak | Normalized | | peak | Normalized |
|---|---|---|---|---|---|
| | position | peak | | position | peak |
| | (2θ) | intensity | | (2θ) | intensity |
| 100% Fe | 28.6 | 0.15298 | Co2C | 37 | 0.26916 |
| | 40 | 0.34618 | | 41.276 | 0.34273 |
| | 42.65 | 0.59736 | | 42.568 | 1 |
| | 43.6 | 0.3909 | | 45.747 | 0.52597 |
| | 44.9 | 1 | | 56.624 | 0.2467 |
| | 50.5 | 0.217 | | | |
| | 53.35 | 0.11691 | | | |

Electrode Preparation. A catalyst ink suspension was prepared using catalyst powder (1.3 mg, 2 mL total volume) in a solution mixture of 10% Nafion (5% (w/w) in water/1-propanol, Beantown Chemical), 6% ethanol, and 84% deionized water. The mixture was then sonicated for 5 min, until a homogeneous black ink formed. Catalyst ink (31 μL) was drop casted onto the surface of a 5 mm diameter glassy carbon (GC) rotating disk electrode (RDE) (Pine Research Instrumentation) with a nanoparticle mass loading of 0.1 mg cm⁻². The samples were dried for 1-2 hr in air at room temperature to achieve a uniform thin film (shown in the SEM image in FIG. 10).

Electrochemical Measurements. All electrochemical measurements were performed using a RIDE setup equipped with an electrode rotator (WaveVortex 10, Pine Research Instrumentation) set to 1500 rpm, connected to a potentiostat (model CH 660E, CH instruments) within a compartmentalized electrochemical glass cell filled with approximately 250 mL of 1.0 M KOH. A three-electrode setup was used with a GC RIDE as the working electrode, a Ag/AgCl reference electrode, and a graphite rod counter electrode.

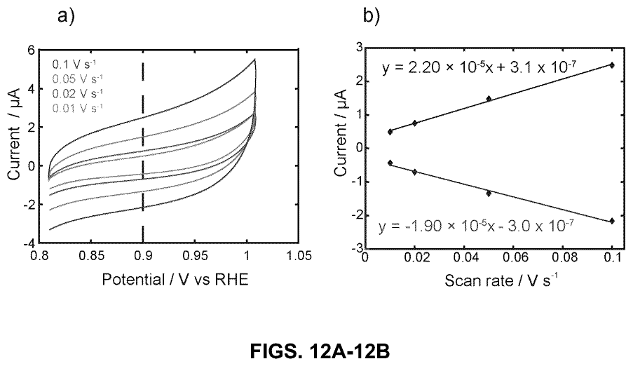

The electrochemical surface area (ECSA) was determined for each sample using the double layer capacitance, C_{dl}, measured by cyclic voltammetry (CV), so that current densities could be estimated (example shown in FIGS. 12A-12B).⁴⁰⁻⁴² The charging current, i_{c}, is proportional to the potential scan rate, v, shown in the relationship

$${i}_{c} = v {C}_{dl} \qquad ( 1 )$$

By varying the scan rate (10, 20, 50 and 100 mV s⁻¹), a plot of i_{c} as a function of v will yield a straight line where C_{dl} is the gradient, using CVs recorded in a designated potential window of the nonfaradaic region of the CV, shown in example CV in FIGS. 12A-12B as 0.80 to 1.0V vs. RHE. ECSA was calculated using the determined value of C_{dl} using

$$ECSA = {C}_{dl} / {C}_{s} \qquad ( 2 )$$

where Cₛ is the specific capacitance of the material. We used a value for Cₛ of 45 μF cm⁻² for the FeₓCo₁₋ₓC_{y} samples, based on reported values in literature for TMs on GC electrodes in the range of 30-70 μF cm⁻².^{43,44}

In 1.0 M KOH electrolyte, the potentials against Ag/AgCl can be converted to potentials vs. the reversible hydrogen electrode (RHE) using

$${E}_{vs . RHE} = {E}_{vs . Ag / AgCl} + 1.0 \; 09 V \qquad ( 3 )$$

which was used to calculate the overpotential, η, using

$$η = {E}_{v s . R H E} - 1.23 V \qquad ( 4 )$$

Additionally, a master reference electrode (not used in experiments) was compared against the Ag/AgCl reference electrode used experimentally and was maintained at a less than a 5 mV difference to ensure a stable, well-defined electrochemical potential.

Tafel slopes were calculated from the linear kinetic region of the Tafel plot, i.e. log (current density) vs. overpotential, at the early onset current in the LSV curves. Electrochemical stability measurements were performed for 200 repetitive CV cycles, with a potential range of 0.8 to 1.0 V vs. RHE, using a scan rate of 5 mV s⁻¹. For the preparation of samples analyzed by pXRD post-OER, nanomaterial was drop casted onto a glassy carbon wafer electrode setup with an estimated mass loading of 0.8 mg cm⁻².

### Results and Discussion

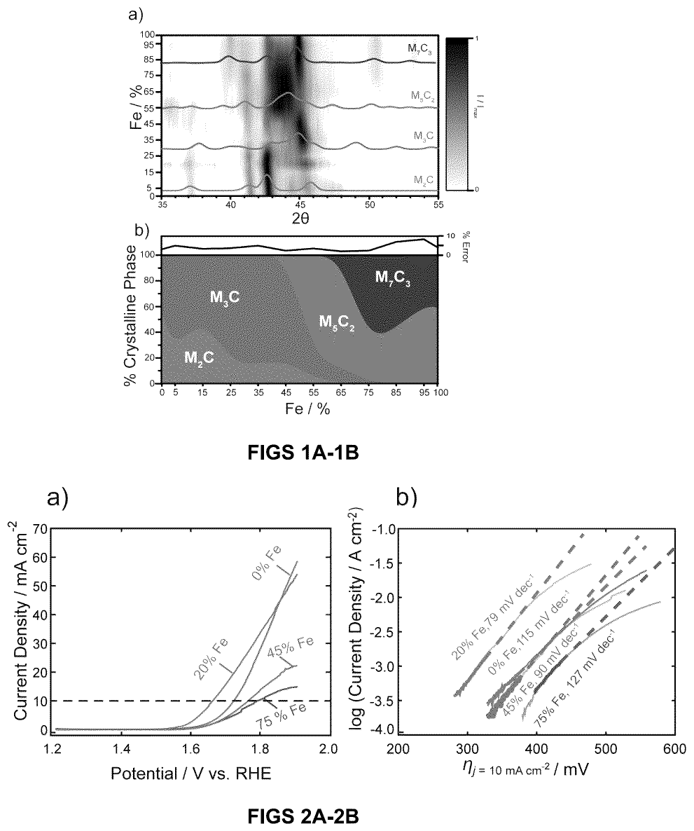

Evolution of Crystal Phase and Surface Chemical States in FeₓCo₁₋ₓC_{y}. The preparation of pure-phase Fe carbide materials is notoriously difficult to achieve under mild synthesis conditions, often resulting in mixed phase materials.^{18,20,45,46} Powder XRD phase analysis of the FeCo nanocarbides reveals an evolution of crystal phases across the various percentages of Fe (FIG. 1). Specifically, FIG. 1a displays the powder XRD patterns as a function of Fe percentage and FIG. 1b shows a percentage stacked area chart for the phase contributions found in the FeₓCo₁₋ₓC_{y} system. Four unique phases are present in this system (FIG. 1b). However, identifying which phase is present and in what amount is a non-trivial task due to diffraction pattern overlap and differences in diffraction intensity. To deconvolute contributions of each phase towards the overall diffraction patterns, whole pattern fitting was executed using Rigaku SmartLab Studio II software. Because there are no known metastable FeCo carbide phases to reference against, the known Fe and Co carbide phases are used as references (Fe₂C, Fe₃C, Fe₅C₂, Fe₇C₃, Co₂C and Co₃C). Of these, the best fitting references were selected and broadened to reflect 10 nm diameter particles and employed in the overall pattern fitting (Co₂C, Co₃C, Fe₅C₂, and Fe₇C₃, from here on defined as M₂C, M₃C, M₅C₂ and M₇C₃, respectively). The whole pattern fits including individual phase contributions are available in FIG. 7. According to our fits, all samples contain a minimum of two crystal phases. Based on the whole pattern fits, the M₃C (ICSD: 43521, orthorhombic) phase seems to primarily dominate the carbide system from 0-45% Fe. Notably, the M₂C (COD: 1528415, orthorhombic) phase coexists in this region and reaches two maxima at 0% and 15% Fe. The M₃C concentration decreases as the Fe concentration increases, until it finally dissipates around 65% Fe. The M₅C₂ (ICSD: 423885, monoclinic) phase appears starting at 55% Fe, where the amount of M₃C phase decreases. From 55-65% Fe, the M₅C₂ persists as the major phase and decreases in abundance at 75% Fe, where the final phase M₇C₃(ICSD: 76830) evolves in. M₇C₃ reaches its maximum at 85% and remains, mixed with M₅C2, from 85-100% Fe.

XRF was used to probe the elemental composition, as seen in Table 1, the ratio of Fe and Co was maintained from PBA precursor to carbide. There is reasonable agreement between the measured Fe:Co ratio, and desired ratio based on synthesis, so all samples are referred to by the desired % Fe content throughout this work. Based on TEM images in this work and in our previous study, the nanocrystals are highly disordered with stacking faults likely present (FIG. 9).²⁵ Stacking faults occur when two or more crystalline phases coexist within the same crystal, creating unique lattice distortions. The presence of significant amounts of amorphous carbon surrounding our nanocarbides prevented high quality TEM imaging, so the images were used only to estimate particle size and shape. The spherical nanoparticle materials range from 10-50 nm in diameter, following the general trend that as the % Fe increased, the particle size decreased (FIG. 9). We believe the carbide synthesis follows a similar top-down synthetic mechanism to that of our previous work,³⁹ and the major phase is modulated through % Fe.

Electrocatalytic Activity of FeₓCo₁₋ₓC_{y} Exhibits Non-Linear Dependence on Fe content. The nanocarbides were assessed for electrocatalytic activity and stability towards the OER in 1.0 M KOH, using a three-electrode set up and a mass loading of 0.1 mg cm⁻². Electrocatalytic activities of the FeCo nanocarbides were evaluated by extracting the overpotential required to achieve a current density of 10 mA cm⁻² from linear sweep voltammograms (LSVs). This value is the benchmarking standard for current density expected at the anode for an artificial photo-synthetic device yielding 10% efficiency at 1 sun illumination, and serves as a useful comparison for our samples and literature.^{47,48} The electrochemically active surface areas (ECSAs) were determined from the electrochemical double layer capacitance of the drop casted surface to allow for comparison of intrinsic activity between samples (representative example shown in FIGS. 12A-12B). This is necessary because the materials have both crystalline and amorphous features, the latter of which tend to have enhanced ECSAs. FIG. 2a shows representative LSVs of the nanocarbides with their corresponding Tafel slopes in FIG. 2b. The best performing FeCo nanocarbide electrocatalyst with the lowest overpotential (0.40 V) was 20% Fe. For comparison, a drop casted industrial electrocatalyst RuO₂ was tested in the same set up, which gave an overpotential of 0.36 V at 10 mA cm⁻², comparable to values shown in literature (0.38 V).¹² The overpotentials achieved, and the voltammetric behavior, were dependent on the % Fe. For example, FeCo nanocarbides containing 20% Fe exhibited lower overpotentials and steeper voltametric slopes than % Fe below or above this value. In addition, as the % Fe increases, we observe that the FeCo nanocarbides are less efficient electrocatalysts that achieve higher overpotentials and lower maximum current densities at 1.9 V. These voltammetric differences warranted Tafel analysis to gain insight into the kinetics of the electrocatalytic OER reaction, shown in FIG. 2b.

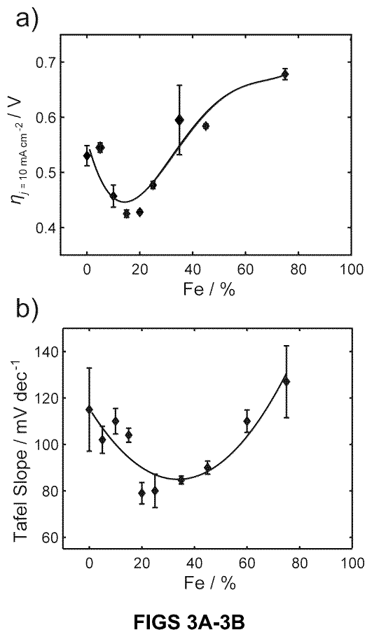

The overpotentials at 10 mA cm⁻² were extracted from each voltammogram and are plotted against the % Fe in FIG. 3a. A U-shaped curve is observed with a minimum overpotential between 15-20% Fe. The monometallic nanocarbide with 0% Fe (i.e. 100% Co) achieved an overpotential of 0.53 V (at 10 mA cm⁻²), and the mixed phase M₅C₂/M₇C₃ (100% Fe) carbide was unable achieve a current density of 10 mA cm⁻² in this potential window, and is therefore not shown. In FIG. 3b, the corresponding Tafel slopes showed a similar U-shaped curve, with a favorable Tafel slope minima observed between 20-25% Fe. Tafel plots allow for the kinetic region of a voltammogram to be analyzed, although unlike for the HER, the value of the Tafel slope cannot be used for directly predicting the mechanism of the OER, given the multi-electron reaction and many possible intermediates.^{4,49,50} However, Tafel slopes of 120 mV dec⁻¹, 90 mV dec⁻¹, 60 mV dec⁻¹, and 30 mV dec⁻¹ can be correlated to 1, 2, 3, and 4 electron transfer processes, respectively, under alkaline conditions.⁴² Comparison of Tafel slopes, albeit without full interpretation, is useful to compare the relative kinetics of the various samples. The most favorable kinetics for the OER were observed at 20-25% Fe, with a Tafel slope of 79 mV dec⁻¹, comparable to a Tafel slope of 85 mV dec⁻¹ for RuO₂ and suggesting a 2 electron-transfer rate determining step. FeCo nanocarbides with lower Fe content, i.e. 0-15% Fe, have Tafel slopes ranging from approximately 115 to 104 mV dec⁻¹, respectively, suggesting that the 0% Fe sample is closest to the 1 electron-transfer rate determining step. Similarly, 75% Fe has a high Tafel slope of 127 mV dec⁻¹, suggesting that Fe content <15% and >75% have less favorable electron transfer kinetics.

The results from our FeCo nanocarbide system reveal optimal geometric and ECSA normalized overpotentials (15-20% Fe) of 0.40 V and 0.42 V, respectively, which are competitive to a geometric-normalized overpotential of a Co₂C OER pre-catalyst reported by Kim et al. of 0.46 V.²¹ It is important to note that when comparing electrocatalysts in literature, there are various methods by which the material is attached to a substrate electrode. Electrode modification methods other than drop casting, such as electrodeposition and sputtering, will result in different film thicknesses and catalytic loading, which can influence the measured overpotentials. However, we theorize that the differences in optimal % Fe to achieve the lowest overpotential across different bimetallic Fe-containing systems could result in part from the roles of crystalline phase and disorder on electrocatalytic activity. Although phase is a potential factor, it cannot be the only contributing factor, as nanocarbides between 0-20% Fe have similar phase compositions, but differing overpotentials. Carbides in particular are known to have amorphous and graphitic-type interstitial carbon that could influence phase, therefore impacting OER activity as Fe is incorporated into the lattice.⁴⁶ It has been reported that strain in materials can often be the result of substitutional doping^{51,52} and disorder.⁵³ Specifically, engineering catalysts utilizing tensile and compressive strain, modeled using density-functional theory calculations, has been a known effective method of regulating electrocatalytic activity.⁵⁴⁻⁵⁸ Strain in functional materials can often be impacted by carbon modification,⁵⁸ and it would be imperative to have a better understanding of how carbon modification and lattice strain contributions impact the design of bi- and multi-metallic carbide electrocatalysts that contain complex, graphitic layers.

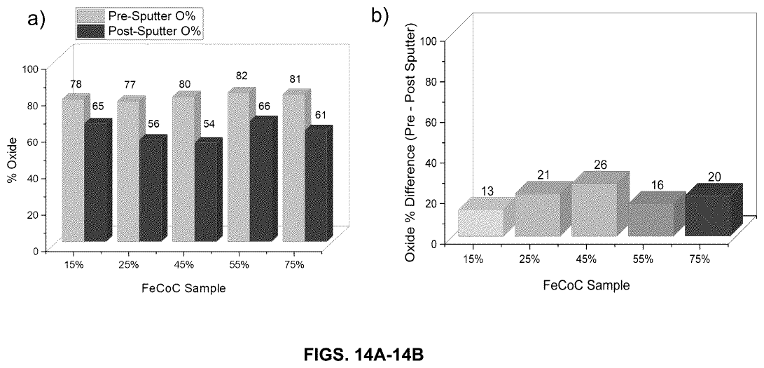

Additionally, the causation of the effect that Fe has on electrocatalytic OER activity is highly speculated in the literature. These theories of iron's role in OER include; favorable binding energies of intermediate species in OER induce stabilization of the crystalline lattice,²⁹ Fe³⁺ acting as the catalytic active site in both FeCo and FeNi materials,^{28,30} and Fe having increased conductivity over other TMs.²⁸ However, the exact mechanism by which Fe incorporation enhances electrocatalytic activity of bimetallic systems is still heavily speculated on in the field, with different systems resulting in optimal overpotentials at different amounts of Fe. For example, FeNi(OOH) of varying Fe content exhibit a lowest overpotential (˜0.38 V) at 25% Fe,³⁰ whereas sea urchin-like FeCo phosphides are optimal (0.37 V) at 50% Fe,³¹ and FeCo (OOH) are optimal (0.35 V) at 60-70% Fe,²⁸ despite having the same two metals as studied in our system. X-ray photoelectron spectroscopy (XPS) was executed on several of our nanocarbide samples to investigate possible differences in electronic structure, however no significant chemical shifts were found in either the Fe2p or Co2p spectra (FIGS. 13A-13B and Table 2). In the XPS quantification there was evidence of a thin surface oxide layer on the nanoparticle which suggests that OER enhancement is due to surface chemistry phenomena. The relative atomic percentage of oxygen and metal in the carbide materials before and after Ar⁺ sputtering is shown in FIGS. 14A-14B. Interestingly, 15% Fe had the smallest change in oxide via sputtering which could suggest a more stable, or possibly thinner, oxide surface in comparison to the other samples.

TABLE 2
Table of all XPS chemical shifts for selected FeₓCo₁₋ₓCy samples.
All chemical shifts were calibrated to C1s = 284.8 eV. No clear
trend is correlative to experimental electrocatalysis results, and
minimal changes are seen in the overall electronic environment.

| | Co Chemical | Fe Chemical | C Chemical | O Chemical |
|---|---|---|---|---|
| Sample | Shifts (eV) | Shifts (eV) | Shifts (eV) | Shifts (eV) |
| 0% Fe | Co⁰: 777.8 | N/A | C—M: 284.8 | O—M: 529.9 |
| | Co²⁺: 778.7 | | C—C: 286.4 | O—C: 531.4 |
| | Co³⁺: 781.0 | | C—O: 288.7 | |
| 15% Fe | Co⁰: 778.1 | Fe⁰: 706.8 | M—C: 284.8 | O—M: 529.2 |
| | Co²⁺: 778.7 | Fe²⁺: 707.9 | C—C: 286.5 | O—C: 531.1 |
| | Co³⁺: 780.8 | Fe³⁺: 710.6 | C—O: 288.8 | |
| 25% Fe | Co⁰: 778.4 | Fe⁰: 707.3 | M—C: 284.8 | O—M: 530.3 |
| | Co²⁺: 778.9 | Fe²⁺: 709.9 | C—C: 285.3 | O—C: 531.9 |
| | Co³⁺: 781.0 | Fe³⁺: 712.6 | C—O: 287.4 | |
| 45% Fe | Co⁰: 777.9 | Fe⁰: 705.6 | M—C: 284.8 | O—M: 529.7 |
| | Co²⁺: 778.8 | Fe²⁺: 706.8 | C—C: 285.5 | O—C: 531.3 |
| | Co³⁺: 781.2 | Fe³⁺: 708.9 | C—O: 287.0 | |
| 55% Fe | Co⁰: 778.3 | Fe⁰: 706.9 | M—C: 284.8 | O—M: 530.2 |
| | Co²⁺: 779.9 | Fe²⁺: 708.3 | C—C: 286.3 | O—C: 531.9 |
| | Co³⁺: 782.8 | Fe³⁺: 710.7 | C—O: 288.4 | |
| 75% Fe | Co⁰: 778.4 | Fe⁰: 707.0 | M—C: 284.8 | O—M: 530.1 |
| | Co²⁺: 779.2 | Fe²⁺: 708.6 | C—C: 286.2 | O—C: 532.0 |
| | Co³⁺: 783.4 | Fe³⁺: 710.7 | C—O: 288.4 | |

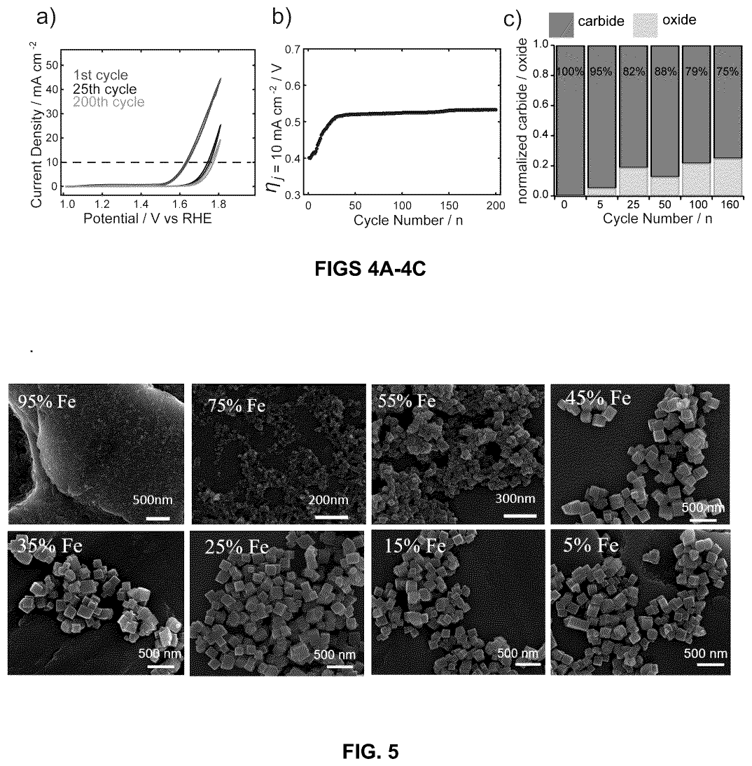

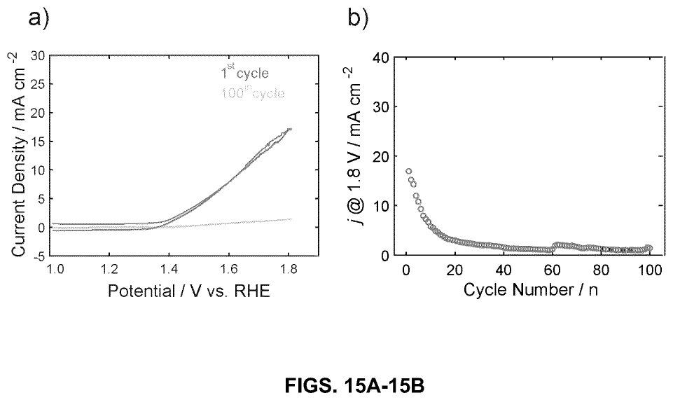

Electrochemical Transformation of FeₓCo₁₋ₓC_{y} During Oxygen Evolution Reaction Under Alkaline Conditions. The electrocatalytic stability of one of the best performing FeCo nanocarbide, 15% Fe, was tested and compared against commercial RuO₂ nanoparticles. This was done using CV repetitive cycling (FIG. 4a), so that overpotentials could be extracted at 10 mA cm⁻² from each voltammogram (FIG. 4b), in alkaline conditions using a RDE set up. It was evident that although the initial OER activity was greater for commercial RuO₂ than the nanocarbides in the first cycle, the electrocatalytic OER stability of the RuO₂ nanoparticles was greatly affected by harsh OER alkaline conditions upon further cycling (FIGS. 15A-15B). Given the rapid loss in activity, after ten cycles the current density no longer achieved the benchmarking current density of 10 mA cm⁻². Therefore, the maximum current density observed at 1.8 V was extracted from the CVs to show the loss of performance. The current density decreased by more than half after just ten cycles which is a 92% reduction of the original value after 100 cycles. Under the same conditions, the 15% Fe nanocarbide showed a 28% increase in overpotential (loss of activity) of ˜100 mV in the first 30 cycles (FIG. 4). After 30 cycles the overpotential remained relatively stable, up to the 200 CV cycles tested (with minimal overpotential change of less than 4% observed from 30 to 200 cycles). The near overlapping CVs of the 25^{th} and 200^{th} cycles in FIG. 4a show that the current densities are relatively similar, suggesting similar electrochemical activity.

To ascribe the increase in overpotential to material degradation, it is important consider other factors which may decrease apparent electrochemical activity, such as the formation of bubbles that block active sites of the electrode surface, physical detachment of the nanomaterial, and hydrophobic/hydrophilic properties of the nanomaterial and the underlying electrode.^{59,60} To avoid some of these limiting factors, our measurements were monitored by visual inspection every five cycles and large bubbles were removed from the electrode surface when they appeared. Mullins and coworkers showed that Co₂C transforms into an amorphous CoO, with an enhancement in OER activity after the first two LSV sweeps.²¹ To determine whether the rapid increase in overpotential (in the first 30 cycles) for our 15% Fe was due to oxide reconstruction or other material transformation changes, we analyzed the material using pXRD analysis before and after OER electrochemical analysis at 5, 25, 50, 100, and 160 cycles (FIG. 4c). At zero cycles, an oxide layer is not detectable by pXRD, however we have evidence for an oxide layer present using XPS (FIGS. 14A-14B). After five cycles, there was 5% (FeₓCo₁₋ₓ)₂O₄ present, but all the materials analyzed after 30 or more cycles showed the presence of approximately 20% (FeₓCo₁₋ₓ)₂O₄ phase. Notably, the greater rate of increase of the formation of spinel oxide in the first 25 cycles correlates with the rapid decline of the OER activity. These results are in agreement with our previously reported observation that a thicker oxide layer on monometallic Fe nanocarbides led to a loss of electrocatalytic activity, where the lowest electrocatalytic activity was observed for the thickest oxide layer after 20 CV cycles.²⁵

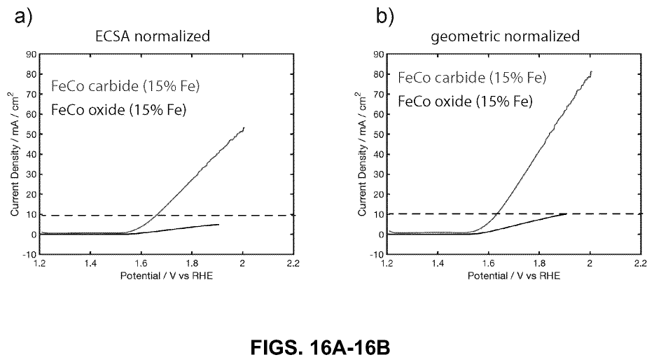

FeCo oxides were synthesized directly from PBAs (pXRD shown in FIG. 9) and also tested for electrochemical activity to investigate whether they also exhibited lower activities than the as-synthesized FeCo nanocarbides which had undergone transformation to FeCo spinel oxides. Both the in situ electrochemically oxidized FeCo nanocarbides and the PBA-derived FeCo oxides resulted in lower electrocatalytic OER activity than the nanocarbides (shown in FIGS. 16A-16B). PBA-derived 15% Fe oxide yielded an average overpotential at 10 mA cm⁻² (per geometric area) of 0.70 V, and when normalized to ECSA a current density of 10 mA cm⁻² was no longer achieved (LSVs available in FIGS. 16A-16B). These represented significantly lower OER activity as compared to the in situ electrochemically oxidized 15% Fe nanocarbides at the 1St CV cycle (0.41 V) and even the 200^{th} cycle (0.53 V). The 170 mV overpotential difference between the in situ electrochemically oxidized FeCo nanocarbides and the PBA-derived FeCo oxides could be explained by the difference in the amount of oxide phase present. The in situ oxidized FeCo nanocarbides contain 25% of the (FeₓCo₁₋ₓ)₂O₄ phase at 160 cycles during OER, while PBA-derived FeCo oxides are approximately 100% (FeₓCo₁₋ₓ)₂O₄ phase, with only a residual amount of the CoO phase. Similar cobalt oxide nanocatalysts, such as CoO and Co₃O₄, exhibited geometric overpotentials achieved for a current density of 10 mA cm⁻² of 0.45 V and 0.50 V respectively,¹² significantly lower than the 0.70 V achieved for our PBA-derived 15% Fe nanocarbide electrocatalyst. Fe oxide nanocatalysts reported in literature exhibited much higher overpotentials, such as 1.23 V at 10 mA cm⁻² for Fe₂O₃,¹² and 0.45 V at 1 mA cm⁻² for Fe₃O₄.⁶¹ Rather than anticipating FeCo carbide electrocatalysts to evolve similarly to other monometallic Co carbides in literature,^{25,35} in terms of electrocatalytic activity and oxide layer growth, we hypothesize that OER activity can be dependent on material descriptors that result from the harsh oxidative environment, which include the active oxide phase,⁶² phase crystallinity, and the amount of oxide phase. Further investigation of stability and oxide transformation in the carbide family and other non-oxide materials will contribute to improving fundamental knowledge of designing efficient non-oxide electrocatalysts for the OER.

### CONCLUSIONS

In this work, various controlled ratios of Fe:Co in FeₓCo₁₋ₓC_{y} were successfully fabricated through a top-down templated synthetic route, to better understand the material properties that tune the electrocatalytic activity of bimetallic carbides for the OER. FeCo nanocarbides containing 15-20% Fe resulted in optimal overpotentials of 0.42 V (at 10 mA cm-2 per ECSA), with a 100 mV enhancement from the monometallic Co₂C. Electrochemical stability and material properties of one of the best performing nanocarbides, Fe_{0.15}Co_{0.85}C_{y}, were monitored for 200 OER cycles using CV followed by ex-situ pXRD. We observed that the overpotential increased by ˜100 mV within the first 30 cycles, which we attribute to the growth of an (FeₓCo₁₋ₓ)₂O₄ layer. From this work, we showed that the carbide pre-catalysts readily formed surface oxide catalysts, which could further transform to thicker oxide layers with reduced activity, as described in our previous work on monometallic carbides.²⁵ The elemental composition, i.e. proportion of Fe and Co present, showed a synergistic effect to enhance the performance of the FeₓCo₁₋ₓC_{y}, for OER activity. This could result from the individual effects of crystalline phase, oxide layer crystallinity, and the oxide layer thickness (post-OER) changing across the composition range. This study provides a new strategy for developing multi-metallic carbide electrocatalysts, which can exploit these synergistic effects.

It should be emphasized that the above-described embodiments of the present disclosure are merely possible examples of implementations and are set forth only for a clear understanding of the principles of the disclosure. Many variations and modifications may be made to the above-described embodiments of the disclosure without departing substantially from the spirit and principles of the disclosure. All such modifications and variations are intended to be included herein within the scope of this disclosure.

### REFERENCES ADDIN EN. REFLIST

ADDIN Mendeley Bibliography CSL_BIBLIOGRAPHY (1) Li, X.; Zhao, L.; Yu, J.; Liu, X.; Zhang, X.; Liu, H.; Zhou, W. Water Splitting: From Electrode to Green Energy System. Nano-Micro Lett. 2020, 12 (1), 131.
(2) Bard, A. J.; Fox, M. A. Artificial Photosynthesis: Solar Splitting of Water to Hydrogen and Oxygen. Acc. Chem. Res. 1995, 28 (3), 141-145.
(3) Stöckl, F.; Schill, W. P.; Zerrahn, A. Optimal Supply Chains and Power Sector Benefits of Green Hydrogen. Sci. Rep. 2021, 11 (1), 14191.
(4) Liang, Q.; Brocks, G.; Bieberle-Hutter, A. Oxygen Evolution Reaction (OER) Mechanism under Alkaline and Acidic Conditions. J. Phys. Energy 2021, 3 (2), 026001.
(5) Xie, X.; Du, L.; Yan, L.; Park, S.; Qiu, Y.; Sokolowski, J.; Wang, W.; Shao, Y. Oxygen Evolution Reaction in Alkaline Environment: Material Challenges and Solutions. Adv. Funct. Mater. 2022, 32 (21), 2110036.
(6) Roger, I.; Shipman, M. A.; Symes, M. D. Earth-Abundant Catalysts for Electrochemical and Photoelectrochemical Water Splitting. Nat. Rev. Chem. 2017, 1 (003), 0003.
(7) Maeda, K.; Domen, K. Photocatalytic Water Splitting: Recent Progress and Future Challenges. J. Phys. Chem. Lett. 2010, 1 (18), 2655-2661.
(8) Deng, H.; Zhang, C.; Xie, Y.; Tumlin, T.; Giri, L.; Karna, S. P.; Lin, J. Evolution Reaction Catalysts †. J. Mater. Chem. A 2016, 4 (6303), 6824-6830.
(9) Audichon, T.; Napporn, T. W.; Canaff, C.; Morais, C.; Comminges, C.; Kokoh, K. B. IrO2 Coated on RuO2 as Efficient and Stable Electroactive Nanocatalysts for Electrochemical Water Splitting. J. Phys. Chem. C 2016, 120 (5), 2562-2573.
(10) Cao, L.; Luo, Q.; Chen, J.; Wang, L.; Lin, Y.; Wang, H.; Liu, X.; Shen, X.; Zhang, W.; Liu, W.; Qi, Z.; Jiang, Z.; Yang, J.; Yao, T. Dynamic Oxygen Adsorption on Single-Atomic Ruthenium Catalyst with High Performance for Acidic Oxygen Evolution Reaction. Nat. Commun. 2019, 10 (1), 4849.
(11) Lee, Y.; Suntivich, J.; May, K. J.; Perry, E. E.; Shao-Horn, Y. Synthesis and Activities of Rutile IrO2 and RuO2 Nanoparticles for Oxygen Evolution in Acid and Alkaline Solutions. J. Phys. Chem. Lett. 2012, 3 (3), 399-404.
(12) Jung, S.; McCrory, C. C. L.; Ferrer, I. M.; Peters, J. C.; Jaramillo, T. F. Benchmarking Nanoparticulate Metal Oxide Electrocatalysts for the Alkaline Water Oxidation Reaction. J. Mater. Chem. A 2016, 4 (8), 3068-3076.
(13) Myekhlai, M.; Benedetti, T. M.; Gloag, L.; Gongales, V. R.; Cheong, S.; Chen, H. S.; Gooding, J. J.; Tilley, R. D. Increasing the Formation of Active Sites on Highly Crystalline Co Branched Nanoparticles for Improved Oxygen Evolution Reaction Electrocatalysis. ChemCatChem 2020, 12(11), 3126-3131.
(14) Zhang, S.; Zhang, X.; Jiang, G.; Zhu, H.; Guo, S.; Su, D.; Lu, G.; Sun, S. Tuning Nanoparticle Structure and Surface Strain for Catalysis Optimization. J. Am. Chem. Soc. 2014, 136 (21), 7734-7739.
(15) Saddeler, S.; Hagemann, U.; Schulz, S. Effect of the Size and Shape on the Electrocatalytic Activity of Co₃O4 Nanoparticles in the Oxygen Evolution Reaction. Inorg. Chem. 2020, 59 (14), 10013-10024.
(16) Yang, C.; Zhao, R.; Xiang, H.; Wu, J.; Zhong, W.; Li, W.; Zhang, Q.; Yang, N.; Li, X. Ni-Activated Transition Metal Carbides for Efficient Hydrogen Evolution in Acidic and Alkaline Solutions. Adv. Energy Mater. 2020, 10 (37), 1-10.
(17) Cheng, Y. W.; Dai, J. H.; Zhang, Y. M.; Song, Y. Two-Dimensional, Ordered, Double Transition Metal Carbides (MXenes): A New Family of Promising Catalysts for the Hydrogen Evolution Reaction. J. Phys. Chem. C 2018, 122 (49), 28113-28122.
(18) Deng, B.; Wang, Z.; Chen, W.; Li, J. T.; Luong, D. X.; Carter, R. A.; Gao, G.; Yakobson, B. I.; Zhao, Y.; Tour, J. M. Phase Controlled Synthesis of Transition Metal Carbide Nanocrystals by Ultrafast Flash Joule Heating. Nat. Commun. 2022, 13 (1), 2807.
(19) Wan, C.; Leonard, B. M. Iron-Doped Molybdenum Carbide Catalyst with High Activity and Stability for the Hydrogen Evolution Reaction. Chem. Mater. 2015, 27 (12), 4281-4288.
(20) Tang, Y. J.; Liu, C. H.; Huang, W.; Wang, X. L.; Dong, L. Z.; Li, S. L.; Lan, Y. Q. Bimetallic Carbides-Based Nanocomposite as Superior Electrocatalyst for Oxygen Evolution Reaction. ACS App. Mater. Interfaces 2017, 9 (20), 16977-16985.
(21) Kim, J. H.; Kawashima, K.; Wygant, B. R.; Mabayoje, O.; Liu, Y.; Wang, J. H.; Mullins, C. B. Transformation of a Cobalt Carbide (Co3C) Oxygen Evolution Precatalyst. ACS Appl. Energy Mater. 2018, 1 (10), 5145-5150.
(22) Wang, Y.; Wu, Q.; Zhang, B.; Tian, L.; Li, K.; Zhang, X. Recent Advances in Transition Metal Carbide Electrocatalysts for Oxygen Evolution Reaction. Catalysts 2020, 10 (10), 1164.
(23) Masa, J.; Weide, P.; Peeters, D.; Sinev, I.; Xia, W.; Sun, Z.; Somsen, C.; Muhler, M.; Schuhmann, W. Amorphous Cobalt Boride (Co 2 B) as a Highly Efficient Nonprecious Catalyst for Electrochemical Water Splitting: Oxygen and Hydrogen Evolution. Adv. Energy Mater. 2016, 6 (6), 1502313.
(24) Xiao, Y.; Hwang, J. Y.; Sun, Y. K. Transition Metal Carbide-Based Materials: Synthesis and Applications in Electrochemical Energy Storage. J. Mater. Chem. A 2016, 4 (27), 10379-10393.
(25) Nguyen, E. T.; Bertini, I. A.; Ritz, A. J.; Lazenby, R. A.; Mao, K.; McBride, J. R.; Mattia, A. V.; Kuszynski, J. E.; Wenzel, S. F.; Bennett, S. D.; Strouse, G. F. A Single Source, Scalable Route for Direct Isolation of Earth-Abundant Nanometal Carbide Water-Splitting Electrocatalysts. Inorg. Chem. 2022, 61 (35), 13836-13845.
(26) Chung, D. Y.; Lopes, P. P.; Farinazzo Bergamo Dias Martins, P.; He, H.; Kawaguchi, T.; Zapol, P.; You, H.; Tripkovic, D.; Strmcnik, D.; Zhu, Y.; Seifert, S.; Lee, S.; Stamenkovic, V. R.; Markovic, N. M. Dynamic Stability of Active Sites in Hydr(Oxy)Oxides for the Oxygen Evolution Reaction. Nat. Energy 2020, 5(3), 222-230.
(27) Görlin, M.; Chernev, P.; De AraOjo, J. F.; Reier, T.; Dresp, S.; Paul, B.; Krahnert, R.; Dau, H.; Strasser, P. Oxygen Evolution Reaction Dynamics, Faradaic Charge Efficiency, and the Active Metal Redox States of Ni—Fe Oxide Water Splitting Electrocatalysts. J. Am. Chem. Soc. 2016, 138 (17), 5603-5614.
(28) Burke, M. S.; Kast, M. G.; Trotochaud, L.; Smith, A. M.; Boettcher, S. W. Cobalt-Iron (Oxy)Hydroxide Oxygen Evolution Electrocatalysts: The Role of Structure and Composition on Activity, Stability, and Mechanism. J. Am. Chem. Soc. 2015, 137(10), 3638-3648.
(29) Dou, Y.; He, C. T.; Zhang, L.; Al-Mamun, M.; Guo, H.; Zhang, W.; Xia, Q.; Xu, J.; Jiang, L.; Wang, Y.; Liu, P.; Chen, X. M.; Yin, H.; Zhao, H. How Cobalt and Iron Doping Determine the Oxygen Evolution Electrocatalytic Activity of NiOOH. Cell Reports Phys. Sci. 2020, 1 (6), 100077.
(30) Friebel, D.; Louie, M. W.; Bajdich, M.; Sanwald, K. E.; Cai, Y.; Wise, A. M.; Cheng, M. J.; Sokaras, D.; Weng, T. C.; Alonso-Mori, R.; Davis, R. C.; Bargar, J. R.; Norskov, J. K.; Nilsson, A.; Bell, A. T. Identification of Highly Active Fe Sites in (Ni, Fe)OOH for Electrocatalytic Water Splitting. J. Am. Chem. Soc. 2015, 137(3), 1305-1313.
(31) Mendoza-Garcia, A.; Su, D.; Sun, S. Sea Urchin-like Cobalt-Iron Phosphide as an Active Catalyst for Oxygen Evolution Reaction. Nanoscale 2016, 8 (6), 3244-3247.
(32) Lee, S. A.; Oh, S.; Hwang, J. Y.; Choi, M.; Youn, C.; Kim, J. W.; Chang, S. H.; Woo, S.; Bae, J. S.; Park, S.; Kim, Y. M.; Lee, S.; Choi, T.; Kim, S. W.; Choi, W. S. Enhanced Electrocatalytic Activity via Phase Transitions in Strongly Correlated SrRuO3 Thin Films. Energy Environ. Sci. 2017, 10 (4), 924-930.
(33) Sun, W.; Liu, J. Y.; Gong, X. Q.; Zaman, W. Q.; Cao, L. M.; Yang, J. OER Activity Manipulated by IrO 6 Coordination Geometry: An Insight from Pyrochlore Iridates. Sci. Rep. 2016, 6, 38429.
(34) Escalera-López, D.; Czioska, S.; Geppert, J.; Boubnov, A.; Röse, P.; Saragi, E.; Krewer, U.; Grunwaldt, J. D.; Cherevko, S. Phase- And Surface Composition-Dependent Electrochemical Stability of Ir—Ru Nanoparticles during Oxygen Evolution Reaction. ACS Catal. 2021, 11 (15), 9300-9316.
(35) Kim, J.-H.; Kawashima, K.; R. Wygant, B.; Mabayoje, O.; Liu, Y.; H. Wang, J.; Buddie Mullins, C. Transformation of a Cobalt Carbide (Co3C) Oxygen Evolution Precatalyst. ACS Appl. Energy Mater. 2018, 1 (10), 5145-5150.
(36) Sivanantham, A.; Ganesan, P.; Vinu, A.; Shanmugam, S. Surface Activation and Reconstruction of Non-Oxide-Based Catalysts through in Situ Electrochemical Tuning for Oxygen Evolution Reactions in Alkaline Media. ACS Catal. 2020, 10 (1), 463-493.
(37) Xu, J.; Sousa, J. P. S.; Mordvinova, N. E.; Costa, J. D.; Petrovykh, D. Y.; Kovnir, K.; Lebedev, O. I.; Kolen'Ko, Y. V. Al-Induced in Situ Formation of Highly Active Nanostructured Water-Oxidation Electrocatalyst Based on Ni-Phosphide. ACS Catal. 2018, 8(3), 2595-2600.
(38) Li, S.; Peng, S.; Huang, L.; Cui, X.; Al-Enizi, A. M.; Zheng, G. Carbon-Coated Co3+-Rich Cobalt Selenide Derived from ZIF-67 for Efficient Electrochemical Water Oxidation. ACS Appl. Mater. Interfaces 2016, 8 (32), 20534-20539.
(39) Hardy, D. A.; Nguyen, E. T.; Parrish, S. E.; Schriber, E. A.; Schlicker, L.; Gili, A.; Kamutzki, F.; Hohman, J. N.; Strouse, G. F. Prussian Blue Iron-Cobalt Mesocrystals as a Template for the Growth of Fe/Co Carbide (Cementite) and Fe/Co Nanocrystals. Chem. Mater. 2019, 31 (19), 8163-8173.
(40) Hominins, T. A.; Evolution, H.; Publishing, B. Some Thoughts about Reporting the Electrocatalytic Performance of Nanomaterials. Appl. Mater. Today 2004, 2(1979), 71-83.
(41) McCrory, C. C. L.; Jung, S.; Ferrer, I. M.; Chatman, S. M.; Peters, J. C.; Jaramillo, T. F. Benchmarking Hydrogen Evolving Reaction and Oxygen Evolving Reaction Electrocatalysts for Solar Water Splitting Devices. J. Am. Chem. Soc. 2015, 137(13), 4347-4357.
(42) Anantharaj, S.; Ede, S. R.; Karthick, K.; Sam Sankar, S.; Sangeetha, K.; Karthik, P. E.; Kundu, S. Precision and Correctness in the Evaluation of Electrocatalytic Water Splitting: Revisiting Activity Parameters with a Critical Assessment. Energy Environ. Sci. 2018, 11 (4), 744-771.
(43) Pell, W. G.; Zolfaghari, A.; Conway, B. E. Capacitance of the Double-Layer at Polycrystalline Pt Electrodes Bearing a Surface-Oxide Film. J. Electroanal. Chem. 2002, 532 (1-2), 13-23.
(44) Lukaszewski, M.; Soszko, M.; Czerwihski, A. Electrochemical Methods of Real Surface Area Determination of Noble Metal Electrodes—an Overview. Int. J. Electrochem. Sci. 2016, 11 (6), 4442-4469.
(45) Gong, Q.; Wang, Y.; Hu, Q.; Zhou, J.; Feng, R.; Duchesne, P. N.; Zhang, P.; Chen, F.; Han, N.; Li, Y.; Jin, C.; Li, Y.; Lee, S. T. Ultrasmall and Phase-Pure W2C Nanoparticles for Efficient Electrocatalytic and Photoelectrochemical Hydrogen Evolution. Nat. Commun. 2016, 7, 1700051.
(46) Lin, Z.; Cai, L.; Lu, W.; Chai, Y. Phase and Facet Control of Molybdenum Carbide Nanosheet Observed by In Situ TEM. Small 2017, 13 (35), 1700051.
(47) McCrory, C. C. L.; Jung, S.; Peters, J. C.; Jaramillo, T. F. Benchmarking Heterogeneous Electrocatalysts for the Oxygen Evolution Reaction. J. Am. Chem. Soc. 2013, 135 (45), 16977-16987.
(48) Walter, M. G.; Warren, E. L.; McKone, J. R.; Boettcher, S. W.; Mi, Q.; Santori, E. A.; Lewis, N. S. Solar Water Splitting Cells. Chem. Rev. 2010, 110 (11), 6446-6473.
(49) Alobaid, A.; Wang, C.; Adomaitis, R. A. Mechanism and Kinetics of HER and OER on NiFe LDH Films in an Alkaline Electrolyte. J. Electrochem. Soc. 2018, 165 (15), 3395-3404.
(50) Seh, Z. W.; Kibsgaard, J.; Dickens, C. F.; Chorkendorff, I.; Norskov, J. K.; Jaramillo, T. F. Combining Theory and Experiment in Electrocatalysis: Insights into Materials Design. Science 2017, 355 (6321), 4998.
(51) Zhang, P.; Cheng, N.; Li, M.; Zhou, B.; Bian, C.; Wei, Y.; Wang, X.; Jiang, H.; Bao, L.; Lin, Y.; Hu, Z.; Du, Y.; Gong, Y. Transition-Metal Substitution-Induced Lattice Strain and Electrical Polarity Reversal in Monolayer WS2. ACS App. Mater. Interfaces 2020, 12 (16), 18650-18659.
(52) Zhang, F.; He, L.; Lian, S.; Wang, M.; Chen, X.; Yin, J.; Pan, H.; Ren, J.; Chen, M. Investigation of Strain and Transition-Metal Doping Effect on Hydrogen Evolution Reaction Catalysts of Mo2C, MoP, and Ni2P. J. Phys. Chem. C 2021, 125 (35), 19119-19130.
(53) Sharma, R.; Karlsen, M. A.; Morgen, P.; Chamier, J.; Ravnsbok, D. B.; Andersen, S. M. Crystalline Disorder, Surface Chemistry, and Their Effects on the Oxygen Evolution Reaction (OER) Activity of Mass-Produced Nanostructured Iridium Oxides. ACS Appl. Energy Mater. 2021, 4 (3), 2552-2562.
(54) Retuerto, M.; Pascual, L.; Pique, O.; Kayser, P.; Salam, M. A.; Mokhtar, M.; Alonso, J. A.; Peña, M.; Calle-Vallejo, F.; Rojas, S. How Oxidation State and Lattice Distortion Influence the Oxygen Evolution Activity in Acid of Iridium Double Perovskites. J. Mater. Chem. A 2021, 9 (5), 2980-2990.
(55) Gu, L. F.; Li, C. F.; Zhao, J. W.; Xie, L. J.; Wu, J. Q.; Ren, Q.; Li, G. R. Dual Modulation of Lattice Strain and Charge Polarization Induced by Co(OH)2/Ni(OH)2 Interfaces for Efficient Oxygen Evolution Catalysis. J. Mater. Chem. A 2021, 9 (22), 13279-13287.
(56) Qin, Y.; Yu, T.; Deng, S.; Zhou, X. Y.; Lin, D.; Zhang, Q.; Jin, Z.; Zhang, D.; He, Y. B.; Qiu, H. J.; He, L.; Kang, F.; Li, K.; Zhang, T. Y. RuO2 Electronic Structure and Lattice Strain Dual Engineering for Enhanced Acidic Oxygen Evolution Reaction Performance. Nat. Commun. 2022, 13 (1), 3784.
(57) Qi, J.; Zhang, Y.; Liu, H.; Xu, H.; Wang, C.; Hu, L.; Feng, M.; LO, W. Strain Modified Oxygen Evolution Reaction Performance in Epitaxial, Freestanding, and Van Der Waals Manganite Thin Films. Nano Lett. 2022, 22, 7066-7072.
(58) Li, G.; Yang, Q.; Rao, J.; Fu, C.; Liou, S. C.; Auffermann, G.; Sun, Y.; Felser, C. In Situ Induction of Strain in Iron Phosphide (FeP2) Catalyst for Enhanced Hydroxide Adsorption and Water Oxidation. Adv. Funct. Mater. 2020, 30 (12), 1907791.
(59) El-Sayed, H. A.; Weiβ, A.; Olbrich, L. F.; Putro, G. P.; Gasteiger, H. A. OER Catalyst Stability Investigation Using RDE Technique: A Stability Measure or an Artifact? J. Electrochem. Soc. 2019, 166 (8), F458-F464.
(60) Geiger, S.; Kasian, O.; Mingers, A. M.; Nicley, S. S.; Haenen, K.; Mayrhofer, K. J. J.; Cherevko, S. Catalyst Stability Benchmarking for the Oxygen Evolution Reaction: The Importance of Backing Electrode Material and Dissolution in Accelerated Aging Studies. ChemSusChem 2017, 10 (21), 4140-4143.
(61) Müllner, M.; Riva, M.; Kraushofer, F.; Schmid, M.; Parkinson, G. S.; Mertens, S. F. L.; Diebold, U. Stability and Catalytic Performance of Reconstructed Fe 3 O 4 (001) and Fe 3 O 4 (110) Surfaces during Oxygen Evolution Reaction. J. Phys. Chem. C 2019, 123 (13), 8304-8311.
(62) Lee, W. H.; Han, M. H.; Ko, Y. J.; Min, B. K.; Chae, K. H.; Oh, H. S. Electrode Reconstruction Strategy for Oxygen Evolution Reaction: Maintaining Fe—CoOOH Phase with Intermediate-Spin State during Electrolysis. Nat. Commun. 2022, 13 (1), 605.

1. An iron/cobalt carbide compound, wherein the molar ratio of cobalt to iron is from about 2:1 to about 5:1.

2. The iron/cobalt carbide compound of claim 1, wherein the compound has the formula Fe_{X}Co_{1-X}C, wherein X is from about 0.05 to about 0.30.

3. The iron/cobalt carbide compound of claim 2, wherein X is from about 0.15 to about 0.25.

4. The iron/cobalt carbide compound of claim 1, wherein the iron/cobalt carbide compound is produced by the process comprising
(a) mixing an iron salt with a cobalt salt in water to produce FeCo Prussian blue analog (PBA); and
(b) heating PBA to produce the iron/cobalt carbide compound.

5. The iron/cobalt carbide compound of claim 4, wherein the iron salt comprises K₃Fe(CN)₆ and the cobalt salt comprises K₃Co(CN)₆.

6. The iron/cobalt carbide compound of claim 4, wherein step (a) further comprises adding a second iron salt or a second cobalt salt.

7. The iron/cobalt carbide compound of claim 6, wherein the second iron salt comprises FeCl₂ and the second cobalt salt comprises CoCl₂.

8. The iron/cobalt carbide compound of claim 4, wherein PBA is heated at a temperature of from about 250° C. to about 500° C.

9. The iron/cobalt carbide compound of claim 1, wherein the compound has a particle size from about 5 nm to about 100 nm.

10. The iron/cobalt carbide compound of claim 1, wherein the compound has an overpotential of from about 0.30 V to about 0.50 V.

11. The iron/cobalt carbide compound of claim 1, wherein the compound has a Tafel slope of from about 70 mV dec⁻¹ to about 90 mV dec⁻¹.

12. The iron/cobalt carbide compound of claim 1, wherein the iron/cobalt carbide compound comprises a Co₃C orthorhombic phase.

13. The iron/cobalt carbide compound of claim 1, wherein the iron/cobalt carbide compound comprises a Co₃C orthorhombic phase and a Co₂C orthorhombic phase.

14. The iron/cobalt carbide compound of claim 1, wherein the compound has an X-ray powder diffraction pattern comprising a peak at from 42.0° to 43.0° 2θ as measured by X-ray powder diffraction using an x-ray wavelength of 1.54 Å.

15. The iron/cobalt carbide compound of claim 1, wherein the compound has an X-ray powder diffraction pattern comprising a peak at from 41.0° to 42.0° 2θ as measured by X-ray powder diffraction using an x-ray wavelength of 1.54 Å.

16. The iron/cobalt carbide compound of claim 1, wherein the compound has an X-ray powder diffraction pattern comprising a peak at from 45.0° to 46.0° 2θ as measured by X-ray powder diffraction using an x-ray wavelength of 1.54 Å.

17. An electrode comprising the iron/cobalt carbide compound of claim 1.

18. The electrode of claim 17, wherein the iron/cobalt carbide compound comprises a film on the surface of the electrode.

19. An oxygen evolution system comprising one or more electrodes of claim 17.

20. The system of claim 19, wherein the system comprises a water electrolysis system, a solar fuel generator, an electrowinning system, an electrolytic hydrogen generator, a reversible fuel cell, or a reversible air battery.
